(19) United States
(12) Patent Application Publication
(10) Pub. No.: US 2016/0116171 A1
(43) Pub. Date: Apr. 28, 2016

(54) OVEN AIRFLOW CONTROL

(71) Applicant: General Electric Company, Schenectady, NY (US)

(72) Inventors: Eric Scott Johnson, Louisville, KY (US); Stephen Christopher Boedicker, Louisville, KY (US)

(21) Appl. No.: 14/520,641

(22) Filed: Oct. 22, 2014

(51) Int. Cl. F24C 3/12; A23L 1/01; F24C 15/32

(52) U.S. Cl. CPC F24C 3/122; F24C 15/322; A23L 1/0128; A23V 2002/00

(57) ABSTRACT

An oven appliance is provided with one or more features for modifying the airflow within the cooking chamber of the oven appliance to help overcome a change in the heating environment of the cooking chamber after a door of the oven is opened and closed. Further, a method for operating an oven appliance is provided. The method includes features for modifying the airflow within the cooking chamber of the oven appliance to help overcome a change in the heating environment of the cooking chamber after a door of the oven is opened and closed.

### FIELD OF THE INVENTION

The subject matter of the present disclosure relates generally to an oven appliance and a method for operating an oven appliance to control airflow within the cooking chamber of the oven.

### BACKGROUND OF THE INVENTION

Oven appliances usually include a cabinet that defines a cooking chamber for cooking food items placed therein through an opening in the cabinet selectively accessed through a door that covers the opening when the door is in a closed position. To heat the cooking chamber for cooking, such as for baking or broiling the food items, oven appliances include one or more heating elements positioned at a top portion, bottom portion, or both of the cooking chamber. Some oven appliances also include a convection heating element and fan for convection cooking cycles. The heating element or elements may be used for various cycles of the oven appliance, such as a preheat cycle, a cooking cycle, or a self-cleaning cycle.

During a typical preheat cycle, the air and surfaces of the cooking chamber are heated to a set temperature, creating a heating environment within the cooking chamber for cooking food items. During a cooking cycle, the heating environment is maintained to cook the food items. Opening the door of the oven appliance during the cooking cycle can change the heating environment of the cooking chamber and thereby alter the cooking performance of the oven appliance, which can affect, e.g., the quality and cook time of the food items. Modifying the convection airflow within the cooking chamber can help overcome the change in the heating environment occasioned by the opening of the door during the cooking cycle.

Accordingly, an oven appliance with features for modifying the airflow within the cooking chamber of the oven appliance to help overcome a change in the heating environment of the cooking chamber after a door of the oven is opened and closed would be useful. Further, a method for operating an oven appliance to modify the airflow within the cooking chamber of the oven appliance to help overcome a change in the heating environment of the cooking chamber after a door of the oven is opened and closed would be beneficial.

### BRIEF DESCRIPTION OF THE INVENTION

The present invention provides an oven appliance with one or more features for modifying the airflow within the cooking chamber of the oven appliance to help overcome a change in the heating environment of the cooking chamber after a door of the oven is opened and closed. Further, a method for operating an oven appliance is provided. The method includes features for modifying the airflow within the cooking chamber of the oven appliance to help overcome a change in the heating environment of the cooking chamber after a door of the oven is opened and closed. Additional aspects and advantages of the invention will be set forth in part in the following description, may be apparent from the description, or may be learned through practice of the invention.

In a first exemplary embodiment, a method for operating an oven appliance is provided. The oven appliance includes a cooking chamber configured for receipt of food items for cooking, one or more heating elements for heating the cooking chamber, and a fan for creating a convection airflow within the cooking chamber. The method includes the steps of initiating a cooking cycle of the oven appliance; establishing a normal convection airflow within the cooking chamber; determining whether a door of the oven appliance has been opened during the cooking cycle and, if so, then starting to count a time tₒₚₑₙ; and determining whether the door of the oven appliance has been closed and, if so, then stopping counting the time tₒₚₑₙ; and determining whether the cooking performance in the cooking chamber has been altered and, if so, then modifying the convection airflow.

In a second exemplary embodiment, an oven appliance is provided. The oven appliance includes a cabinet defining an opening at a front portion of the cabinet, the cabinet also defining a cooking chamber configured for receipt of food items for cooking; a door mounted to the cabinet at the opening of the cabinet, the door being selectively adjustable between an open position and a closed position to permit selective access to the cooking chamber through the opening of the cabinet; a heating element configured to heat the cooking chamber; a fan configured to create a convection airflow within the cooking chamber; and a controller in operative communication with the heating element and the fan. The controller is configured for initiating a cooking cycle of the oven appliance; establishing a normal convection airflow within the cooking chamber; determining whether a door of the oven appliance has been opened during the cooking cycle and, if so, then starting to count a time tₒₚₑₙ; and determining whether the door of the oven appliance has been closed and, if so, then stopping counting the time tₒₚₑₙ; and determining whether the cooking performance in the cooking chamber has been altered and, if so, then modifying the convection airflow.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of an exemplary embodiment of an oven appliance of the present subject matter.

FIG. 2 is a cross-sectional view of the oven appliance of FIG. 1 taken along the 2-2 line of FIG. 1.

FIG. 3 provides a chart illustrating an exemplary method for operating an oven appliance according to the present subject matter.

FIG. 4 provides a graph of the heating rate and temperature of food items in a cooking chamber of an oven appliance in accordance with a present method of operating the oven appliance.

FIG. 5 provides a graph of the heating rate and temperature of food items in a cooking chamber of an oven appliance in accordance with an exemplary embodiment of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

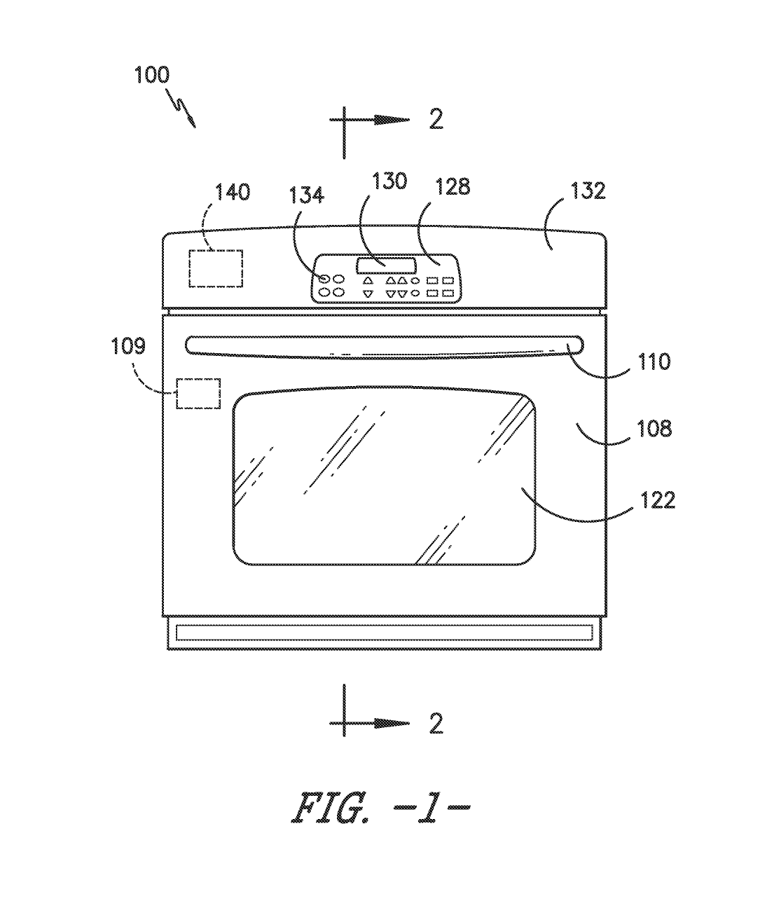

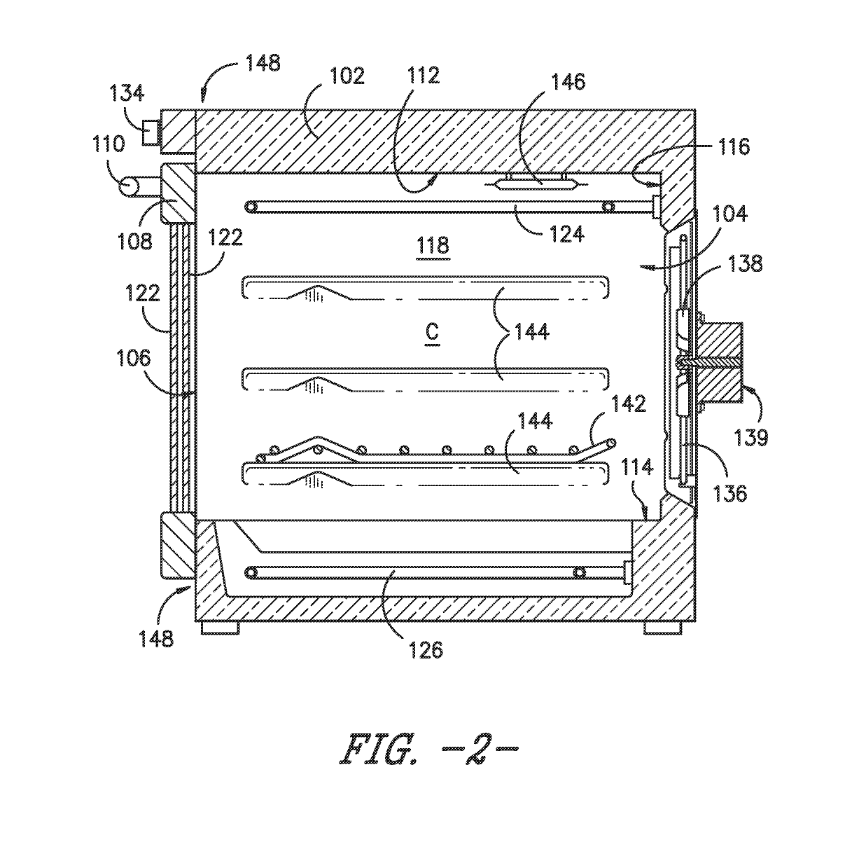

Referring to FIGS. 1 and 2, for this exemplary embodiment, oven appliance 100 includes an insulated cabinet 102 with an interior cooking chamber 104 defined by a top wall 112, a bottom wall 114, a back wall 116, and opposing side walls 118, 120. Cooking chamber 104 is configured for the receipt of one or more food items to be cooked. Oven appliance 100 includes a door 108 pivotally mounted, e.g., with one or more hinges (not shown), to cabinet 102 at the opening 106 of cabinet 102 to permit selective access to cooking chamber 104 through opening 106. A door sensor 109 may be positioned, e.g., on or in door 108 or cabinet 102 to sense whether door 108 is open or closed. Sensor 109 may be, e.g., a switch, a magnetic pickup, or any other appropriate sensor. A handle 110 is mounted to door 108 and assists a user with opening and closing door 108. For example, a user can pull on handle 110 to open or close door 108 and access cooking chamber 104.

Oven appliance 100 can include a seal (not shown) between door 108 and cabinet 102 that assists with maintaining heat and cooking fumes within cooking chamber 104 when door 108 is closed as shown in FIGS. 1 and 2. Multiple parallel glass panes 122 provide for viewing the contents of cooking chamber 104 when door 108 is closed and assist with insulating cooking chamber 104. A baking rack 142 is positioned in cooking chamber 104 for the receipt of food items or utensils containing food items. Baking rack 142 is slidably received onto embossed ribs or sliding rails 144 such that rack 142 may be conveniently moved into and out of cooking chamber 104 when door 108 is open.

A heating element at the top, bottom, or both of cooking chamber 104 provides heat to cooking chamber 104 for cooking, e.g., during bake and/or broil cooking cycles. Such heating element(s) can be gas, electric, microwave, or a combination thereof. For example, in the embodiment shown in FIG. 2, oven appliance 100 includes a top heating element 124 and a bottom heating element 126, where bottom heating element 126 is positioned adjacent to and below bottom wall 114. Other configurations with or without wall 114 may be used as well.

Oven appliance 100 also has a convection heating element 136 and convection fan 138 positioned adjacent back wall 116 of cooking chamber 104. Convection fan 138 is powered by a convection fan motor 139, and a piece or layer of insulation (not shown) may be positioned between fan 138 and fan motor 139. Further, convection fan 138 can be a variable speed fan—meaning the speed of fan 138 may be controlled or set anywhere between and including, e.g., 0 and 100 percent. The speed of convection fan 138 can be determined by, and communicated to, fan 138 by controller 140. In other embodiments, convection fan 138 may be a single speed fan that is operated in a duty cycle such that fan 138 is alternated between an off state and an on state; each state lasts for a period of time that may be determined or set by, e.g., controller 140. The period of time for the off state may or may not be equal to the period of time for the on state, and the period of time for each state may be varied during, e.g., cooking cycles of oven appliance 100. As an example, convection fan 138 may cycle between an on state lasting 30 seconds and an off state lasting 30 seconds during one portion of a cooking cycle, and fan 138 may cycle between an on state lasting 45 seconds and an off state lasting 15 seconds during another portion of a cooking cycle. Other ways of operating fan 138 may also be used. Additionally, in other embodiments, oven appliance 100 may use other configurations of heating elements 124, 126, 136 and fan 138 or may include other heating elements and/or fans in addition to or in place of heating elements 124, 126, 138 and fan 138.

Oven appliance 100 includes a user interface 128 having a display 130 positioned on an interface panel 132 and having a variety of controls 134. Interface 128 allows the user to select various options for the operation of oven 100 including, e.g., temperature, time, and/or various cooking and cleaning cycles. Operation of oven appliance 100 can be regulated by a controller 140 that is operatively coupled, i.e., in communication with, user interface 128, heating elements 124, 126, and other components of oven 100 as will be further described.

For example, in response to user manipulation of the user interface 128, controller 140 can operate the heating element(s). Controller 140 can receive measurements from a temperature sensor 146 placed in cooking chamber 104 and, e.g., provide a temperature indication to the user with display 130. Controller 140 can also be provided with other features as will be further described herein.

Controller 140 may include a memory and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, sensor 146, alarms, and/or other components as may be provided. In one embodiment, user interface 128 may represent a general purpose I/O (“GPIO”) device or functional block.

Although shown with touch type controls 134, it should be understood that controls 134 and the configuration of oven appliance 100 shown in FIG. 1 is provided by way of example only. More specifically, user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. User interface 128 may be in communication with controller 140 via one or more signal lines or shared communication busses.

While oven 100 is shown as a wall oven, the present invention could also be used with other cooking appliances such as, e.g., a stand-alone oven, an oven with a stove-top, or other configurations of such ovens.

Oven appliance 100 may have several cooking and cleaning cycles, including a preheat cycle. Generally, the preheat cycle ensures cooking chamber 104 is thermally “soaked,” such that the air temperature in the center of the cooking chamber has reached the cooking temperature and the surfaces of the cooking chamber are heated to a temperature for radiation heat transfer from the surfaces. After the cooking chamber has been preheated, a cooking cycle may be initiated to cook food items placed in cooking chamber 104.

The cooking performance of oven appliance 100, such as, e.g., the heating rate and temperature of the food items within cooking chamber 104, may be altered if door 108 of oven appliance 100 is opened during the cooking cycle. Opening door 108 during the cooking cycle may change the heating environment in cooking chamber 104, e.g., by allowing the air within cooking chamber 104 to cool through heat exchange with the ambient air or migration of heated air out of the cooking chamber through the open door, and a changed heating environment can alter the cooking performance within cooking chamber 104. An altered cooking performance may affect, e.g., the quality of the food items, the cook time, and the like.

Thus, oven appliance 100 may include several features to overcome a change in the heating environment of the cooking chamber that can alter the cooking performance of oven appliance 100. As an example, methods of operating oven appliance 100 may include using controller 140 to detect that the cooking performance has been altered by the opening of door 108 during a cooking cycle and to utilize convection fan 138 to modify the convection airflow within cooking chamber 104 to neutralize the effects of opening door 108. Such features of oven appliance 100 and methods of operating oven appliance 100 will be further described below.

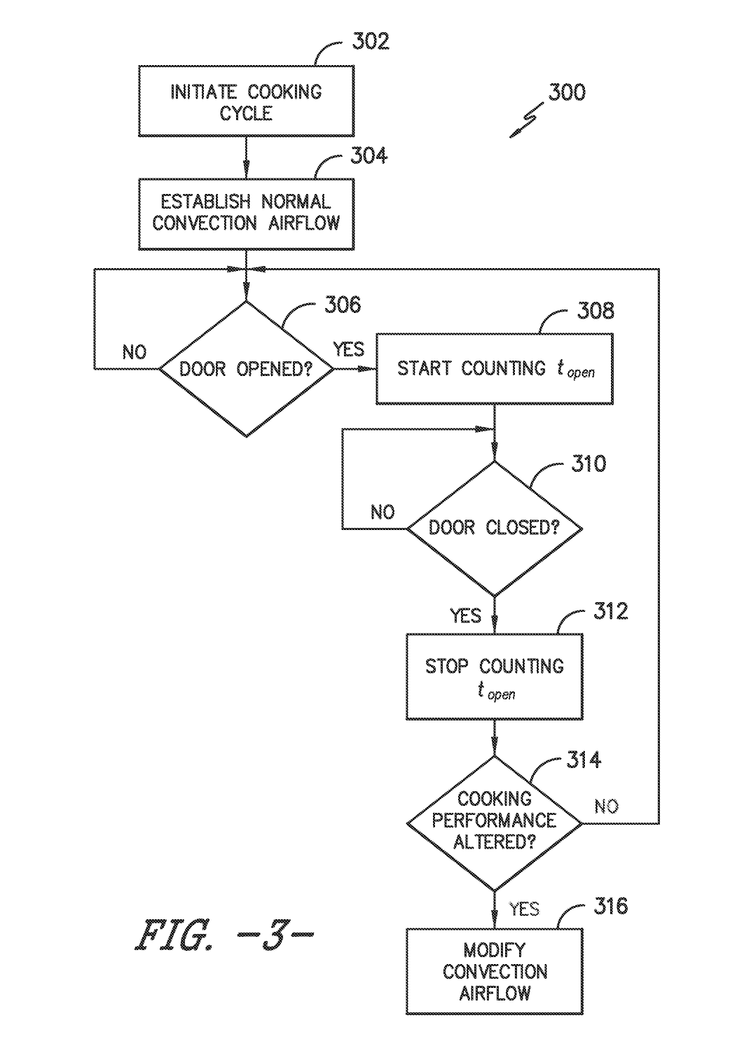

FIG. 3 illustrates an exemplary method of operating oven appliance 100. Although described below as largely performed by controller 140, method 300 may be performed in whole or in part by controller 140 or any other suitable device or devices. At step 302, a cooking cycle of oven appliance 100 is initiated. The cooking cycle may be, e.g., a bake cycle, a broil cycle, a convection cycle, or a combination bake, broil, and convection cycle. The initiation of the cooking cycle may follow a preheat cycle of oven appliance 100, where cooking chamber 104 was heated to a set temperature Tₚᵣₑ over a time tₚᵣₑ, measured from the time the preheat cycle was initiated until temperature Tₚᵣₑ was reached and the preheat cycle was terminated.

One or more cooking cycles may be programmed into, e.g., controller 140 such that the cooking cycle is initiated upon the user's selection of a programmed cooking cycle, i.e., the user's selection of a cooking cycle sends a signal to controller 140 to initiate the cooking cycle. In other embodiments, the user may select one or more parameters of a cooking cycle—such as, e.g., a cooking temperature T_{cook}, the cook mode (bake, broil, convect, or combination), the length of the cooking cycle, etc.—and the cooking cycle is initiated upon the selection of the one or parameters. The user may select a programmed cooking cycle or the parameters of a cooking cycle, e.g., through the manipulation of one or more controls 134. In alternative embodiments, the user may select a programmed cooking cycle or the parameters of a cooking cycle through, e.g., voice commands. Other means of selecting and initiating a cooking cycle may be used as well.

Further, as part of the initiation of the initiation of the cooking cycle, conditions of the cooking cycle and cooking chamber 104 may be measured and/or sensed, or begin to be measured and/or sensed, and stored by, e.g., controller 140. For example, controller 140 may sense the initial temperature Tᵢₙᵢₜᵢₐₗ of cooking chamber 104 when the cooking cycle is initiated. Thus, temperature Tᵢₙᵢₜᵢₐₗ generally is approximately equal to set temperature Tₚᵣₑ. Controller 140 may also begin counting a time t_{cook}, representing the time elapsed from the initiation of the cooking cycle. In addition, controller 140 may count a total time tₒₙ that oven appliance 100 is in operation, i.e., the total time elapsed through the preheat and cooking cycles, or the sum of times tₚᵣₑ and t_{cook}. Other conditions of the cooking cycle and cooking chamber 104 may also be measured, sensed, or the like.

After the cooking cycle is initiated, method 300 includes step 304 of establishing a normal convection airflow. In some embodiments, such as where convection fan 138 is a variable speed fan, controller 140 may establish a normal convection airflow by operating fan 138 at a set speed, e.g., 50 percent speed, that is stored and/or recognized as the normal convection airflow setting. In other embodiments, such as where convection fan 138 is a single speed fan, controller 140 may establish a normal convection airflow by operating fan 138 in a set duty cycle, e.g., alternating fan 138 between an on state lasting 30 seconds and an off state lasting 30 seconds, that is stored and/or recognized as the normal convection airflow setting. In still other embodiments, the normal convection airflow may be established by turning or leaving fan 138 in its off state. Other ways of establishing a normal convection airflow may also be used, such as, e.g., operating other fans that may be provided with oven appliance 100 and/or operating one or more heating elements of cooking chamber 104.

At step 306, controller 140 determines whether door 108 has been opened. If not, controller 140 continues to monitor whether door 108 has been opened. If door 108 has been opened, as shown at step 308, controller 140 starts counting a time tₒₚₑₙ. A temperature Tₒₚₑₙ may also be measured, representing the temperature in cooking chamber 104 when door 108 is opened. Then, method 300 includes step 310 of determining whether door 108 has been closed. If not, controller 140 continues to monitor whether door 108 has been closed. If, however, door 108 has been closed, at step 312 controller 140 stops counting time tₒₚₑₙ. Thus, time tₒₚₑₙ is the time period door 108 was open, i.e., the time elapsed between when controller 140 determined at step 306 that door 108 was open and when controller 140 determined at step 310 that door 108 was closed.

Controller 140 may determine whether door 108 has been opened or closed by sensing the state of door sensor 109. That is, sensor 109 is in one state if door 108 is open, and sensor 109 is in another state if door 108 is closed such that controller 140 may determine whether door 108 is open or closed by sensing the state of sensor 109. In such embodiments, controller 140 may start counting time tₒₚₑₙ at step 308 when sensor 109 changes from the closed state to the open state, and controller 140 may stop counting time tₒₚₑₙ when sensor 109 changes from the open state to the closed state.

Alternatively, controller 140 may determine whether door 108 has been opened or closed by sensing the temperature within cooking chamber 104, e.g., using temperature sensor 146. For example, during a cooking cycle, the temperature within cooking chamber 104 is usually much higher than the ambient temperature of the environment in which oven appliance 100 is located. Thus, when door 108 is opened during a cooking cycle, the temperature within cooking chamber 104 generally decreases due to a loss of heat through the open door. Controller 140 may sense the decrease in temperature, as measured by, e.g., temperature sensor 146, and determine that door 108 has been opened. Similarly, when door 108 has been returned to the closed position during the cooking cycle, the temperature within cooking chamber 104 generally increases as cooler air is heated to the cooking temperature. Controller 140 may sense the increase in temperature and determine that door 108 has been closed. To avoid false determinations of whether door 108 is opened or closed, controller 140 may be programmed to determine that door 108 has been opened if the temperature decreases by a certain amount in a certain period of time and to determine that door 108 has been closed if the temperature increases by a certain amount in a certain period of time. The certain amount of temperature decrease or increase over certain periods of time may be determined, e.g., experimentally for different configurations of oven appliance 100 and programmed into controller 140 during the manufacture of oven appliance 100. Other means of determining whether door 108 has been opened or closed may be used as well.

After door 108 has been returned to the closed position, method 300 includes step 314 of determining whether the cooking performance within cooking chamber 104 has been altered because door 108 was opened. In some embodiments, controller 140 may determine whether the cooking performance was altered based on the time tₒₚₑₙ door 108 was open. In such embodiments, controller 140 may compare time tₒₚₑₙ to a first threshold time tₜₕᵣ₁, and if tₒₚₑₙ is at least equal to tₜₕᵣ₁, then controller 140 may determine that the cooking performance was altered by the opening of door 108. Alternatively, the duration tₒₚₑₙ of the door opening may be used in conjunction with one or more other parameters and/or conditions to determine whether the cooking performance was altered by the opening of door 108. For example, prior door opening times tₒₚₑₙ, the time t_{cook} elapsed from the initiation of the cooking cycle, the times t_{cook} at which prior door opening times tₒₚₑₙ occurred (i.e., whether a prior opening of door 108 occurred relatively recently or in the relatively distant past), the temperature Tₒₚₑₙ in cooking chamber 104 when door 108 is opened, the cook mode, the cooking temperature T_{cook}, and/or the initial cooking chamber temperature Tᵢₙᵢₜᵢₐₗ may be used to determine whether the cooking performance has been altered by the opening of door 108. If it is determined the cooking performance within cooking chamber 104 was not altered by the opening of door 108, method 300 returns to monitoring whether door 108 has been opened.

However, if it is determined the cooking performance within cooking chamber 104 was altered by the opening of door 108, method 300 includes step 316 of modifying the convection airflow within cooking chamber 104. In some embodiments, the convection airflow is modified by increasing the airflow to maintain the heating rate of food items within cooking chamber 104 and to restore the thermal soak of cooking chamber 104. The convection airflow may be increased by, e.g., increasing the speed of convection fan 138 or increasing the duty cycle of fan 138. For example, if fan 138 is operated at 50 percent speed for normal convection airflow, when the convection airflow is modified at step 316, the speed of fan 138 may be increased such that fan 138 is operated at, e.g., 75 percent speed. As another example, if fan 138 is operated in a duty cycle of 30 seconds in the on state and 30 seconds in the off state for normal convection airflow, when the convection airflow is modified at step 316, the duty cycle may be increased such that fan 138 is operated in a duty cycle of 45 seconds in the on state and 15 seconds in the off state. Other fan speeds and duty cycles may be used, and the convection airflow may be increased in other ways as well, such as, e.g., by operating other fans or otherwise increasing air circulation within cooking chamber 104.

Alternatively, the convection airflow may be modified at step 316 by decreasing the airflow to prevent cooler air introduced into cooking chamber 104 when door 108 was open from reducing the heating rate of food items within cooking chamber 104. The convection airflow may be decreased by, e.g., decreasing the speed of convection fan 138 or decreasing the duty cycle of fan 138. For example, if fan 138 is operated at 50 percent speed for normal convection airflow, when the convection airflow is modified at step 316, the speed of fan 138 may be decreased such that fan 138 is operated at, e.g., 25 percent speed. As an additional example, if fan 138 is operated in a duty cycle of 30 seconds in the on state and 30 seconds in the off state for normal convection airflow, when the convection airflow is modified at step 316, the duty cycle may be decreased such that fan 138 is operated in a duty cycle of 15 seconds in the on state and 45 seconds in the off state. Other fan speeds and duty cycles may be used, and the convection airflow may be decreased in other ways as well, such as, e.g., by operating other fans or otherwise decreasing air circulation within cooking chamber 104.

Further, in some embodiments, airflow may be modified by, e.g., increasing or decreasing the speed or duty cycle of fan 138 by a set amount, and fan 138 may operate at the increased or decreased speed or duty cycle for a set period of time t_{mod}. After operating with the modified airflow for time t_{mod}, the normal convection airflow may be re-established. In other embodiments, the length of time tₒₚₑₙ that door 108 was open may determine the magnitude of the modification of the convection airflow at step 316. That is, in embodiments where the convection airflow is modified by increasing the airflow, for a longer time tₒₚₑₙ, the airflow may be increased by a greater amount or increased for a longer period of time. For example, if time tₒₚₑₙ is at least a second threshold time tₜₕᵣ₂, the speed or duty cycle of fan 138 may be increased more, i.e., to a higher level, than if tₒₚₑₙ is less than second threshold time tₜₕᵣ₂. Similarly, for embodiments where the convection airflow is modified by decreasing the airflow, following a longer time tₒₚₑₙ, the airflow may be decreased by a greater amount or decreased for a longer period of time. As an example, if time tₒₚₑₙ is at least second threshold time tₜₕᵣ₂, the speed or duty cycle of fan 138 may be decreased more, i.e., to a lower level, than if tₒₚₑₙ is less than second threshold time tₜₕᵣ₂. Alternatively, the magnitude of the modification of the convection airflow may be determined based on time tₒₚₑₙ, such that the airflow and/or modification period t_{mod} vary for each time tₒₚₑₙ. In such embodiments, the amount the convection airflow is increased or decreased, i.e., the amount by which the fan speed or duty cycle is increased or decreased, and/or the modification period t_{mod} may be determined by, e.g., one or more equations using time tₒₚₑₙ. In addition, prior door opening times tₒₚₑₙ, the time t_{cook} elapsed from the initiation of the cooking cycle, the times t_{cook} at which prior door opening times tₒₚₑₙ occurred (i.e., whether a prior opening of door 108 occurred relatively recently or in the relatively distant past), the temperature Tₒₚₑₙ in cooking chamber 104 when door 108 is opened, the cook mode, the cooking temperature T_{cook}, and/or the initial cooking chamber temperature Tᵢₙᵢₜᵢₐₗ may be used to determine the magnitude of the modification of the airflow within cooking chamber 104.

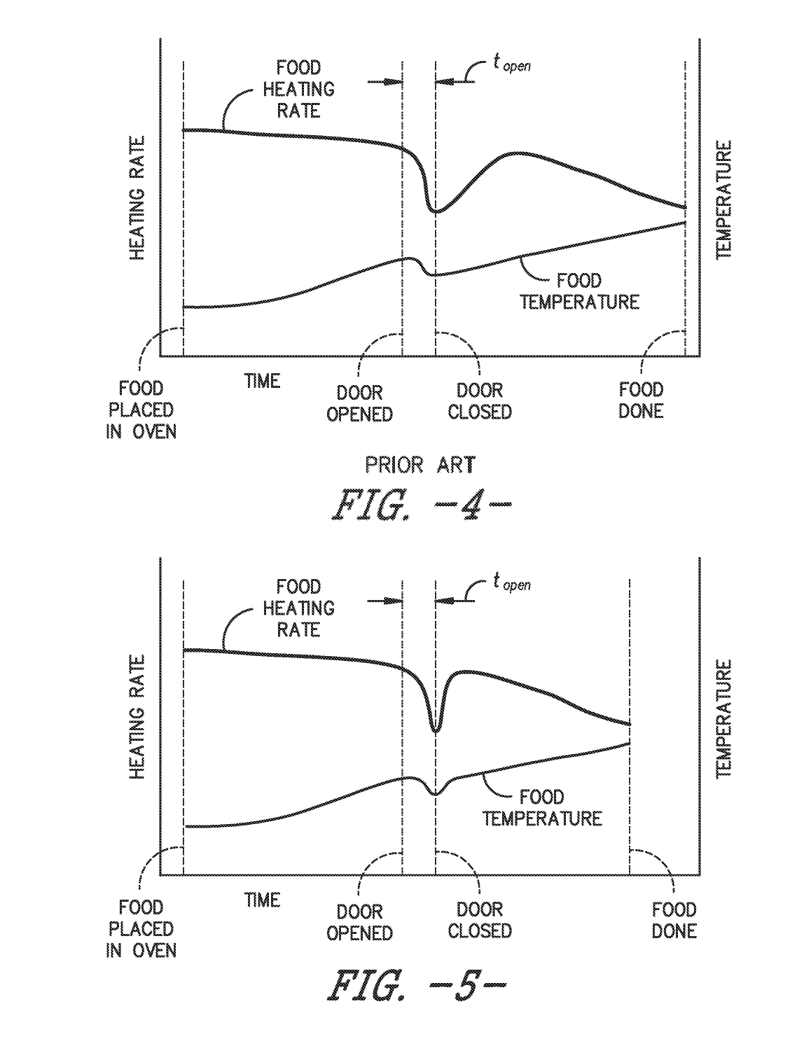

FIGS. 4 and 5, graphing heating rate and temperature over time of food items within cooking chamber 104—using, e.g., data obtained through one or more experiments—show that modifying the convection airflow within the cooking chamber can improve the cooking performance within the cooking chamber. FIG. 4 illustrates the time required for the heating rate and temperature of food items within cooking chamber 104 to recover after door 108 is opened for a period of time tₒₚₑₙ, without modifying the convection airflow within cooking chamber 104, i.e., the current method of operating oven appliance 100. FIG. 5 illustrates the time required for the heating rate and temperature of food items within tₒₚₑₙ cooking chamber 104 to recover after door 108 is opened for a period of time tₒₚₑₙ the airflow within cooking chamber 104 is modified, e.g., as described with respect to exemplary method 300. As shown, the time axis is the same in FIGS. 4 and 5. Thus, comparing FIGS. 4 and 5, operating an oven appliance 100 as described herein shortens the time required for the heating rate and temperature of food items within cooking chamber 104 to recover after door 108 has been open for a period of time tₒₚₑₙ and, accordingly, helps overcome the change in the heating environment occasioned by the opening of the door. As further shown in FIGS. 4 and 5, overcoming the change in the heating environment can shorten the cooking time, as well as, e.g., improve the quality of the food items compared to operating an oven appliance without overcoming the change in the heating environment.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A method for operating an oven appliance, the oven appliance having a cooking chamber configured for receipt of food items for cooking, the oven appliance also having one or more heating elements for heating the cooking chamber and a fan for creating a convection airflow within the cooking chamber, the method comprising the steps of:
initiating a cooking cycle of the oven appliance;
establishing a normal convection airflow within the cooking chamber;
determining whether a door of the oven appliance has been opened during the cooking cycle and, if so, then
determining whether the door of the oven appliance has been closed and, if so, then
modifying the convection airflow.

2. The method of claim 1, wherein the steps of determining whether the door of the oven appliance has been opened or closed comprise sensing the state of a door sensor.

3. The method of claim 1, wherein the steps of determining whether the door of the oven appliance has been opened or closed comprise sensing a temperature within the cooking chamber.

4. The method of claim 1, further comprising the steps of determining whether the cooking performance in the cooking chamber has been altered if the door of the oven appliance has been opened and closed.

5. The method of claim 1, wherein the step of modifying the convection airflow comprises increasing the speed of the fan.

6. The method of claim 1, wherein the step of modifying the convection airflow comprises increasing the duty cycle of the fan.

7. The method of claim 1, wherein the step of modifying the convection airflow comprises decreasing the speed of the fan.

8. The method of claim 1, wherein the step of modifying the convection airflow comprises decreasing the duty cycle of the fan.

9. The method of claim 1, further comprising the steps of starting to count a time tₒₚₑₙ if the door of the oven appliance has been opened during the cooking cycle and stopping counting time tₒₚₑₙ if the door has been closed.

10. The method of claim 1, wherein the step of modifying the convection airflow comprises modifying the airflow for a time t_{mod}.

11. An oven appliance, comprising:
a cabinet defining an opening at a front portion of the cabinet, the cabinet also defining a cooking chamber configured for receipt of food items for cooking;
a door mounted to the cabinet at the opening of the cabinet, the door being selectively adjustable between an open position and a closed position to permit selective access to the cooking chamber through the opening of the cabinet;
a heating element configured to heat the cooking chamber;
a fan configured to create a convection airflow within the cooking chamber; and
a controller in operative communication with the heating element and the fan, the controller configured for
initiating a cooking cycle of the oven appliance;
establishing a normal convection airflow within the cooking chamber;
determining whether the door has been opened and, if so, then
determining whether the door of the oven appliance has been closed and, if so, then
modifying the convection airflow.

12. The oven appliance of claim 11, wherein the controller is configured to sense the state of a door sensor to determine whether the door of the oven appliance has been opened and closed.

13. The oven appliance of claim 11, wherein the controller is configured to sense a temperature within the cooking chamber to determine whether the door of the oven appliance has been opened and closed.

14. The oven appliance of claim 11, wherein the controller is further configured for determining whether the cooking performance in the cooking chamber has been altered if the door of the oven appliance has been opened and closed.

15. The oven appliance of claim 11, wherein the controller is configured to modify the convection airflow by increasing the speed of the fan.

16. The oven appliance of claim 11, wherein the controller is configured to modify the convection airflow by increasing the duty cycle of the fan.

17. The oven appliance of claim 11, wherein the controller is configured to modify the convection airflow by decreasing the speed of the fan.

18. The oven appliance of claim 11, wherein the controller is configured to modify the convection airflow by decreasing the duty cycle of the fan.

19. The oven appliance of claim 11, wherein the controller is further configured for starting to count a time tₒₚₑₙ if the door of the oven appliance has been opened during the cooking cycle and stopping counting time tₒₚₑₙ if the door has been closed.
